(19) United States
(12) Patent Application Publication
(10) Pub. No.: US 2018/0233947 A1
(43) Pub. Date: Aug. 16, 2018

(54) DEVICE OPERATING STATE MODIFICATION WITH UNINTERRUPTIBLE POWER SOURCE

(71) Applicant: HEWLETT PACKARD ENTERPRISE DEVELOPMENT LP, Houston, TX (US)

(72) Inventors: Troy Allen MILLS, Houston, TX (US); Ali ABBAS, Houston, TX (US)

(21) Appl. No.: 15/751,518

(22) PCT Filed: Aug. 13, 2015
(86) PCT No.: PCT/US2015/045085

§ 371 Date: Feb. 9, 2018

(51) Int. Cl. H02J 9/06

(52) U.S. Cl. CPC H02J 9/06

(57) ABSTRACT

In some examples, a method includes determining, with an Uninterruptible Power Supply (UPS), a power state of the UPS; determining, with the UPS, a power state of a device attached to the UPS; determining, with the UPS, whether an action to modify an operating state of the device attached to the UPS should be initiated based on the determined power state of the UPS and the power state of the device attached to the UPS; and initiating, with the UPS, the action to modify the operating state of the device attached to the UPS when it is determined by the UPS that the action should be initiated.

### BACKGROUND

An uninterruptible power supply (UPS) is a device that is designed to provide electrical power to connected equipment, such as computer servers, when a primary input power source for the connected equipment fails. Certain UPS's are designed to provide near-instantaneous protection from input power interruptions by supplying energy stored in batteries, supercapacitors, or other suitable stored energy sources, UPS's can be used to protect hardware such as computers, data centers, telecommunication equipment or other electrical equipment where an unexpected power disruption could cause injuries, business disruption, or data loss.

### BRIEF DESCRIPTION OF DRAWINGS

FIG. 1 is a diagram of a UPS attached to various devices, a computer, and a power source, according to an example.

FIG. 2 is a flowchart for a method, according to an example.

FIG. 3 is a diagram of a UPS, according to an example.

FIG. 4 is a diagram of machine-readable storage medium, according to an example.

FIG. 5 is a timing diagram, according to an example.

FIG. 6 is a Graphical User Interface (GUI) for managing a UPS, according to an example.

FIG. 7 is a GUI for managing devices attached to a UPS, according to an example.

FIG. 8 is a GUI for managing shutdown parameters for devices attached to a UPS, according to an example.

FIG. 9 is a GUI for managing device power settings, according to an example.

### DETAILED DESCRIPTION

The following discussion is directed to various examples of the disclosure. Although one or more of these examples may be preferred, the examples disclosed herein should not be interpreted, or otherwise used, as limiting the scope of the disclosure, including the claims. In addition, the following description has broad application, and the discussion of any example is meant only to be descriptive of that example, and not intended to intimate that the scope of the disclosure, including the claims, is limited to that example. Throughout the present disclosure, the terms “a” and “an” are intended to denote at least one of a particular element. In addition, as used herein, the term “includes” means includes but not limited to, the term “including” means including but not limited to. The term “based on” means based at least in part on.

As provided above, a UPS can be used to provide backup electrical power to attached devices when a primary input power source for the attached devices fail. UPS's can be designed to operate based on power management instructions received from a computer in communication with the UPS over a communication line, such as wired or wireless direct (e.g., Universal Serial Bus (USB) cable) or network connections (e.g., Wi-Fi connection, Ethernet cable, etc.). In some environments, the remote computer can be configured to send an instruction to the UPS to power down an attached device when the remote computer receives information that a primary input power source for the attached device has failed. Various implementations are described herein that provide improvements to existing solutions for managing operating states of devices attached to a UPS.

One implementation of a method is performed by a UPS and is described in further detail herein. The method includes: (1) determining a power state of the UPS; (2) determining a power state of a device attached to the UPS; (3) determining an action to modify an operating state of the device attached to the UPS should be initiated based on the determined power state of the UPS and the power state of the device attached to the UPS; and (4) initiating the action to modify the operating state of the device attached to the UPS when it is determined by the UPS that the action should be initiated.

Certain implementations of the present disclosure can, for example, be used to provide for a UPS-initiated, agentless, graceful, server shutdown accomplished via a network. As an example, a UPS can detect a power failure for an attached server and once the power failure is detected a command set for gracefully shutting down the server can be sent via a network to the server. The command set can, for example, be independent of any Operating System (OS) running on the server. Other advantages of implementations presented herein will be apparent upon review of the description and figures.

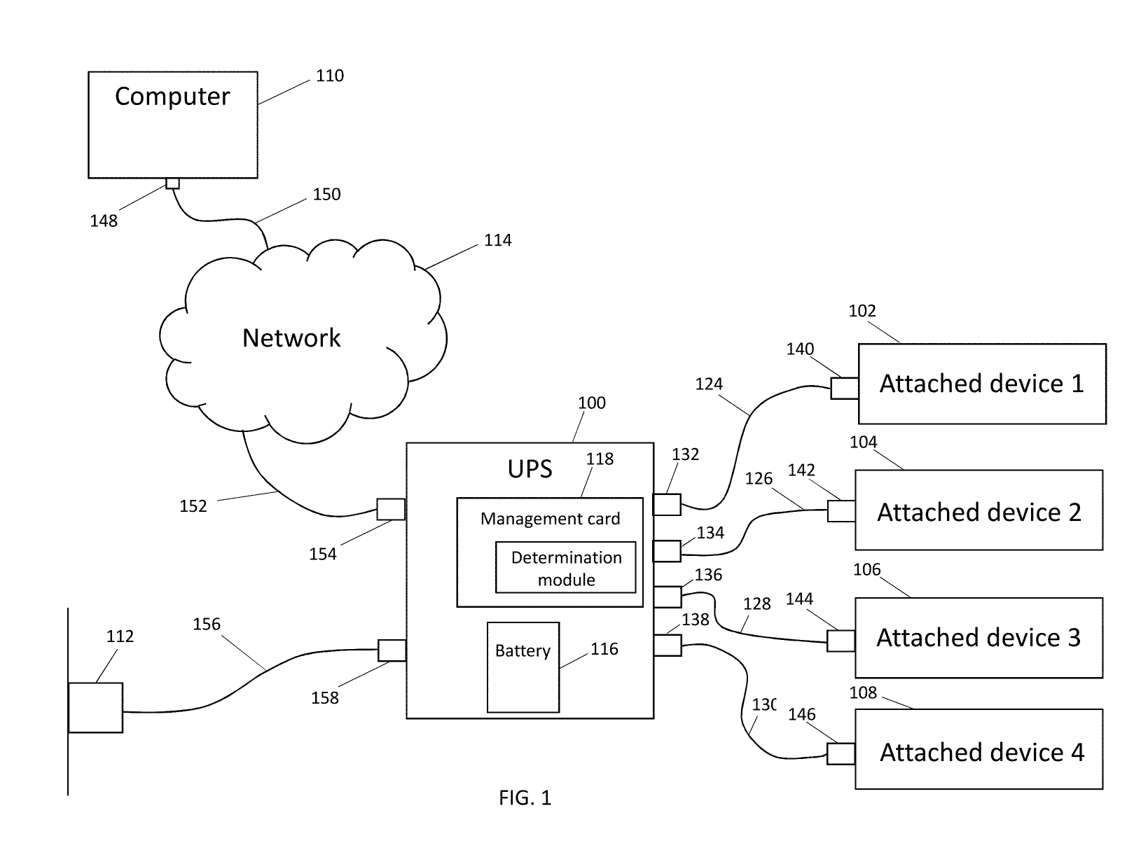

FIG. 1 is a diagram of an example UPS 100 attached to various devices 102, 104, 106, and 108, a computer 110, and a power source 112. UPS 100 can, for example, provide electrical power to connected equipment, such as attached devices 102, 104, 106, and 108 when a primary input power source 112 for the connected equipment fails. UPS 100 can, for example, be in the form of a standalone UPS appliance. In some implementations, UPS 100 can be integrated within a general purpose computer or other equipment for managing UPS using a local connection, such as a bus or internal cabling. However, and as depicted in FIG. 1, UPS 100 can in some implementations be managed by a remote computer 110 in communication with UPS 100 via an intermediary network 114. It is appreciated that in some implementations, network 114 may be further directly connected to one or more of attached devices 102, 104, 106, and 108 such that the attached device(s) can communicate with computer 110 via network 114 without passing through UPS 100. It is further appreciated that attached devices 102, 104, 106, and 108 can be connected to other networks or other devices using direct or indirect connections.

Although the term “UPS” is an industry standard term meaning “Uninterruptible Power Supply,” it is appreciated that there might nevertheless be an acceptable interruption (e.g., a slight interruption may be acceptable for certain devices) in power supply to the attached devices if backup power is needed. In some implementations, UPS 100 can receive power from a single source or two or more sources simultaneously. For example, in some implementations, UPS 100 can be powered directly from an Alternating Current (AC) main power source 112, while simultaneously charging a storage battery 116 housed within a housing of UPS 100. In the event of a dropout or failure of main power source 112, battery 116 can be designed to instantly (or near-instantly) take over so that attached devices 102, 104, 106, and 108 do not experience an interruption.

The example UPS 100 depicted in FIG. 1 includes a management card 118 having a determination module 120 that includes a combination of hardware and software to perform a determination function using internal logic of UPS 100. Management card 118 can, for example, be used to manage power received by UPS 100, manage power transmitted to devices attached to UPS 100, and also to manage the generation and sending of instructions to the devices attached to UPS 100. Management card 118 can, for example, be in the form of a computer hardware component, such as an expansion card, that is installed in UPS 100. In some implementations, management card 118 can be built into a motherboard of UPS 100. It is appreciated that the word “card” in the term “management card” is not intended to dictate a specific form factor, shape, or physical aspect of management card 118 and can include any suitable physical or virtualized equipment.

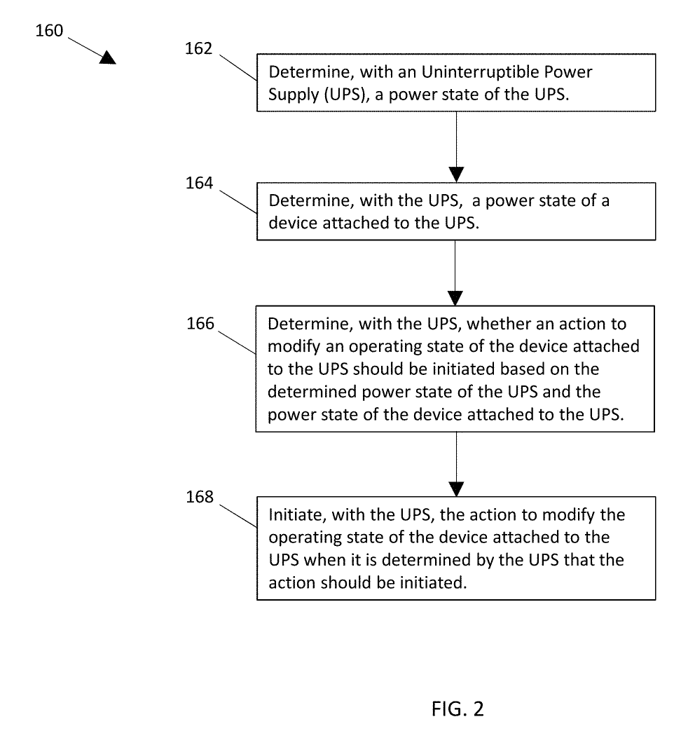

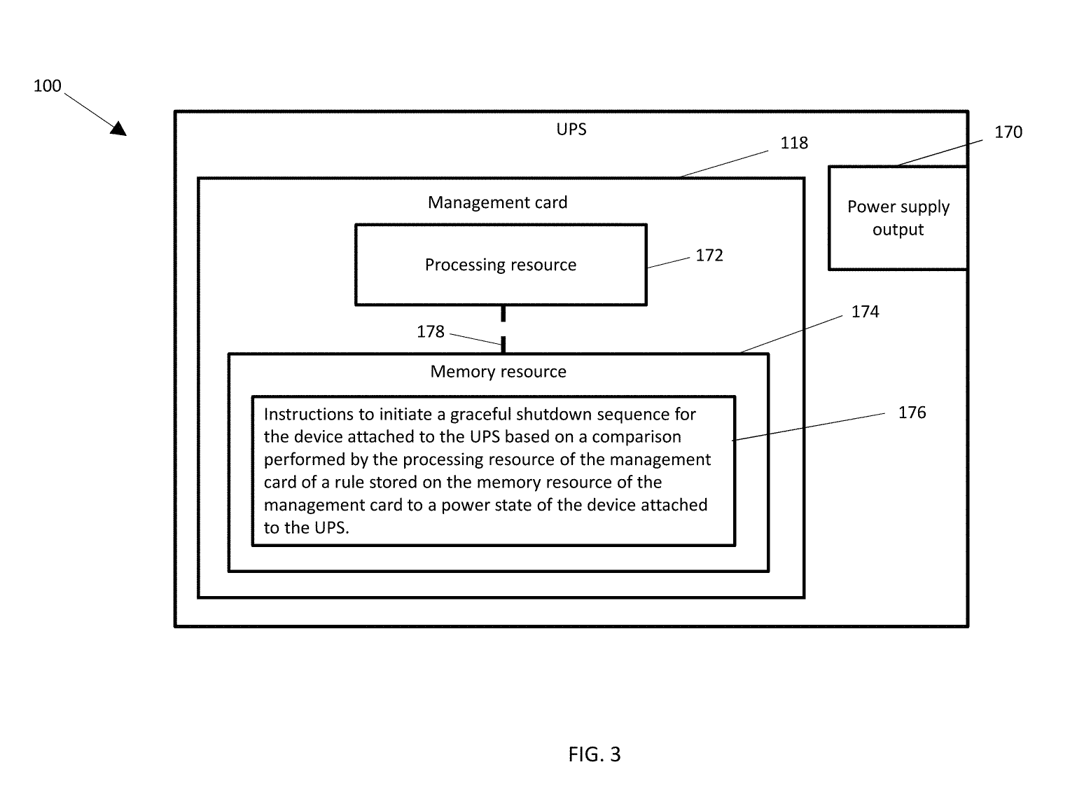

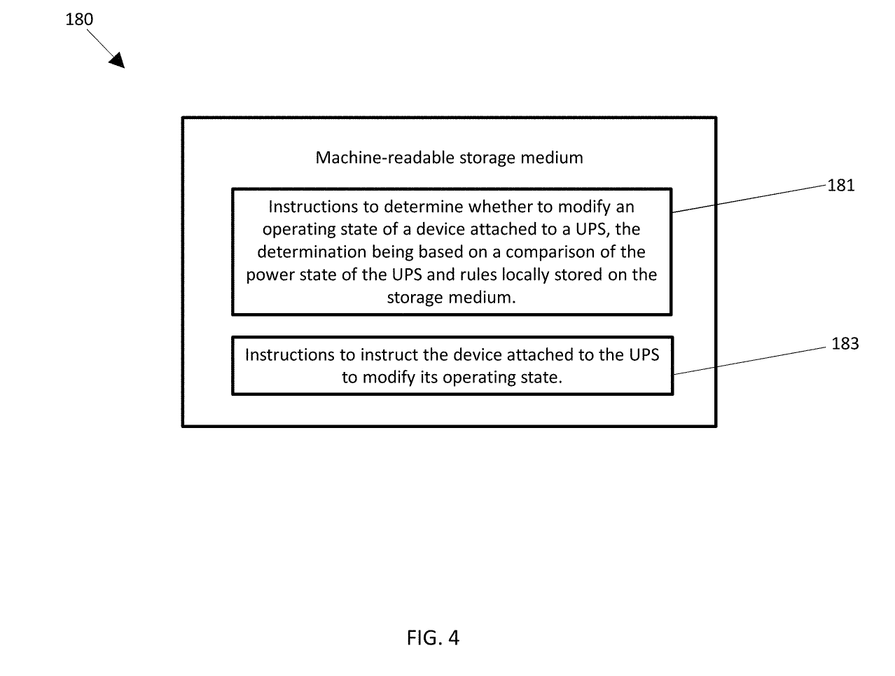

Determination module 120 can, for example, be used to determine whether to modify an operating state of one or more devices (e.g., devices 102, 104, 106, and 108) attached to UPS 100. Further description relating to such a determination is provided below with respect to other implementations, such as the method of FIG. 2, the UPS of FIG. 3, and the medium of FIG. 4. It is appreciated that UPS 100 and/or management card 118 can include additional or alternative modules. For example, in some implementations management card 118 can include a shutdown initiation module 122 that includes a combination of hardware and software to perform a function of initiating a graceful shutdown sequence for a given device attached to UPS 100 based on a comparison performed by a processing resource of management card 118 of a rule stored on a memory resource of management card 118 to a power state of the given device. Further description of such shutdown functionality is provided below with respect to the method of FIG. 2.

The example UPS 100 of FIG. 1 is connected to devices 102, 104, 106, and 108 via respective power links 124, 126, 128, and 130, ports 132, 134, 136, 138 on UPS 100 and respective ports 140, 142, 144, and 146 of devices 102, 104, 106, and 108. Although only one “link” for each device is shown in FIG. 1, it is appreciated that UPS 100 may be connected to each device via multiple links, which can, for example, be in the form of multiple cables (e.g., with a separate link in each cable) or a single cable (e.g., with multiple links in each cable). The various links are able to transmit electrical power for powering the devices. In some implementations, the links are able to further carry data signals for providing instructions to the devices. In some implementations, a first link is provided to transmit electrical power to power a given device (e.g., device 102) and a second link is provided to transmit data signals to power the given device. In some implementations, electrical power for powering the given device and data signals for communicating with the device are both transmitted over a single link. It is appreciated that each single link depicted in FIG. 1 may include multiple wires or other wired or wireless data channels.

Computer 110 can, for example, be any suitable computer for management of UPS 100. In some implementations, computer 110 is in the form of a desktop computer including a monitor for presenting information to an operator and a keyboard and mouse for receiving input from an operator. In some implementations, computer 110 is in the form of headless equipment, such as a headless server or other suitable equipment. Computer 110 can be connected to network 114 via a respective port 148 and link 150. In some implementations, port 148 and link 150 are designed for transmitting data over network 114 (e.g., Ethernet ports and cables).

Network 114 can, for example, be in the form of a Local Area Network (LAN), a Wide Area Network (WAN), or any other suitable network for allowing communication between two devices. In some implementations, UPS 100 is not connected to computer 110 via a network. For purposes of illustration, in FIG. 1, UPS 100 is depicted as being connected to network 114 via a link 152 and port 154 and computer 110 is depicted as being connected to network 114 via a link 150 and port 148. It is appreciated that these links may include multiple wires or other wired or wireless data channels.

In some implementations, ports 148 and link 154 are designed for transmitting data over a direct connection between computer 110 and UPS 100 without passing through an intermediary network. For example, in some implementations, a USB cable can connect computer 110 to UPS 100, with both computer 110 and UPS 100 being located within a single room of a data center. In some implementations, UPS 100 and computer 110 are directly connected using network cables, such as Ethernet cables, without passing through intermediate network hardware (e.g., switches, routers, gateways, etc.).

Power source 112 can, for example, provide power from any suitable type of energy sources, including electrical energy transmission systems, energy storage devices such as a batteries and fuel cells, electromechanical systems such as generators and alternators, solar power converters, or another power supply. Power source 112 can, for example, be in the form of a wall outlet (mains supply) that provides Alternating Current (AC) power. In some implementations, power source 112 can, for example, be in the form of a Direct Current (DC) power supply which supplies a voltage of fixed polarity (either positive or negative) to UPS 100. Power source 112 is connected to UPS 100 via a link 156 and a port 158 on UPS 100. Link 156 is able to transmit electrical power for powering UPS 100. Although only one such link is shown in FIG. 1, it is appreciated that UPS 100 may be connected to UPS 100 via multiple links, which can, for example, be in the form of multiple cables (e.g., with a separate link in each cable) or a single cable (e.g., with multiple links in each cable). Only a single power source 112 is depicted in FIG. 1 for illustration. However, it is appreciated that in some implementations, UPS 100 is supplied by power from multiple power sources 112 for redundancy or other purposes.

Attached devices 102, 104, 106, and 108 can be any suitable device that receives a power input for operation. Such suitable devices can include one or more electrical loads, which are electrical components or portions of a circuit that consume electric power. Example electrical loads include appliances and lights. In some implementations, each attached device is a separate server receiving its own power supply from UPS 100. In some implementations, the attached devices are different types of devices (e.g., two servers, a printer, and a general purpose computer). In some implementations, the attached devices can include their own OS for handling graceful shutdown of the device. The OS can, for example, receive instructions from UPS 100 to initiate an operating state modification (e.g., initiate a shutdown procedure). Further description of attached devices 102, 104, 106, and 108 is provided below with respect to the method of FIG. 2.

FIG. 2 is a flowchart for a method 160 according to an example of the present disclosure. In some implementations, method 160 can be implemented in the form of executable instructions stored on a memory resource (e.g., the memory resource of FIG. 3), executable machine readable instructions stored on a storage medium (e.g., the medium of FIG. 4), in the form of electronic circuitry (e.g., on an Application-Specific Integrated Circuit (ASIC)), and/or another suitable form. For illustration, the description of method 160 and its component steps make reference to example UPS 100 of FIG. 1 and elements thereof, such as devices 102, 104, 106, and 108, computer 110, power source 112, etc. However, it is appreciated that method 160 or aspects thereof can be used or otherwise applicable for any suitable UPS 100 connected to any suitable number of devices 102, 104, 106, and 108, computers 110, power sources 112, etc. As but one example, method 160 can be applied to a UPS connected to more than four devices as illustrated in FIG. 1.

Method 160 includes determining (at block 162) a power state of UPS 100. The term “power state” as used herein, can, for example, refer to an indicator identifying whether given equipment is receiving adequate power and/or can refer to an indicator identifying how the equipment is receiving power. For example, in some implementations, a first power state of UPS 100 can correspond to UPS 100 being supplied power via its primary power supply, a second power state of UPS 100 can correspond to UPS 100 being supplied power via an internal battery 116, a third power state of UPS 100 can correspond to UPS 100 being supplied power via another auxiliary power source, a fourth power state can indicate that the primary power supply of UPS 100 has failed and a secondary power supply of UPS 100 is powering UPS 100. It is appreciated that additional and/or alternative power states may be used.

In some implementations, if power source 112 is experiencing a failure, block 162 can determine a power state for UPS 100 corresponding to adequate power not being supplied to UPS 100. In some implementations, block 162 includes determining whether UPS 100 is currently being supplied by battery power (e.g., by a battery of UPS 100 such as battery 116) or another auxiliary source. In some implementations, the power state of UPS 100 can merely serve as a yes or no flag for whether UPS 100 should provide power to device 102. For example, a bit corresponding to the power state of UPS 100 can be set to “0” when UPS 100 should provide backup power to device 102 and can be set to “1” when UPS 100 is not to provide backup power to device 102. It is appreciated that in some circumstances, a primary power source, such as power source 112, may be providing some trivial or otherwise inadequate amount of power to UPS 100. In such a circumstance, even though UPS 100 is receiving some power from power source 112, UPS 100 may nevertheless determine a power state that corresponds to a power “failure.”

Method 160 includes determining (at block 164) a power state of a device (e.g., device 102 used for purposes of illustration) attached to UPS 100. Similar to block 162, which determines a power state of UPS 100, the power state of device 102 can, for example, identify whether adequate power is being supplied to device 102 by an external power source. In some implementations, the power state of device 102 identifies whether the device is being supplied power by a battery housed within the device. In some implementations, the power state of device 102 can merely serve as a yes or no flag for whether device 102 should receive power from UPS 100. For example, a bit corresponding to the power state of device 102 can be set to “0” when UPS 100 should provide backup power to device 102 and can be set to “1” when UPS 100 is not to provide backup power to device 102.

In some implementations, both UPS 100 and device 102 may receive primary power from the same power supply (e.g., power source 112). It is appreciated that like certain implementations of UPS 100, certain implementations of device 102 can include an internal battery or other auxiliary power supply for powering device 102 in the event of power failure from its primary power supply. In some implementations, UPS 100 is primarily powered by a first powers supply (e.g., power source 112) and device 102 is primarily powered by a second power supply (e.g., a power source other than power source 112). In some implementations, device 102 can be plugged into an AC power main to receive primary power from the main. In some implementations, device 102 can receive primary power through UPS 100. It is appreciated that in some implementations, device 102 can be designed to be powered by multiple sources simultaneously. Further, it is appreciated that in some implementations, device 102 can be directly powered by an internal battery and external power supplies can be used to continuously “top off” the internal battery.

Method 160 includes determining (at block 166) whether an action to modify an operating state of device 102 should be initiated based on the determined power state of UPS 100 and the determined power state of device 102. The term “operating state” as used herein can, for example, refer to information regarding the operation or lack of operation of device 102. For example, in some implementations, a first operating state of device 102 can correspond to device 102 being turned on and running normally, a second operating state of device 102 can correspond to device 102 being in the process of shutting down, a third operating state of device 102 can correspond to device 102 being turned off, and a fourth operating state of device 102 can correspond to device 102 being in the process of rebooting. It is appreciated that additional and/or alternative operating states can be used.

In some implementations, determining whether an action to modify the operating state of device 102 should be initiated includes comparing the determined power state of UPS 100 and the determined power state of device 102 using a local processor (e.g., see processing resource of FIG. 3) of a management card (e.g., management card 118) housed within UPS 100. For example, the local processor can determine that when UPS 100 is running on battery power and when device 102 is not receiving power from its primary power supply, then UPS 100 should initiate a shutdown sequence for device 102.

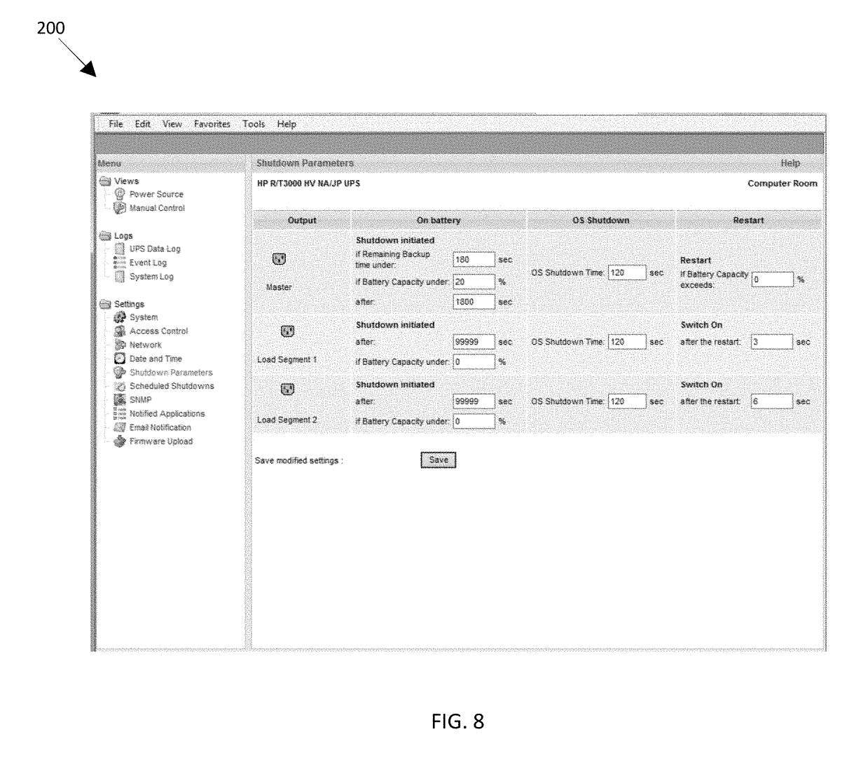

In some implementations, determining whether an action to modify the operating state of the device attached to the UPS should be initiated includes matching the determined power state of the UPS and the determined power state of the device to a rule locally stored on a management card housed within the UPS. The rule can, for example, be locally stored on a memory resource of management card (see, e.g., the memory resource of FIG. 3). For reference, FIG. 8, which is addressed below, provides several examples of rules relating to modifying an operating state of device 102. For example, such a rule can, for example, include criteria based on remaining backup time for UPS 100. Other criteria can, for example, include percentage remaining battery capacity of UPS 100, a countdown timer indicating how long UPS 100 has been running on battery power (e.g., initiate shutdown sequence only after UPS 100 has been running on battery power for at least 1,000 seconds). Such criteria can further include an estimated shutdown time for an OS running on device 102, as well as criteria relating to restarting device 102 after shutdown.

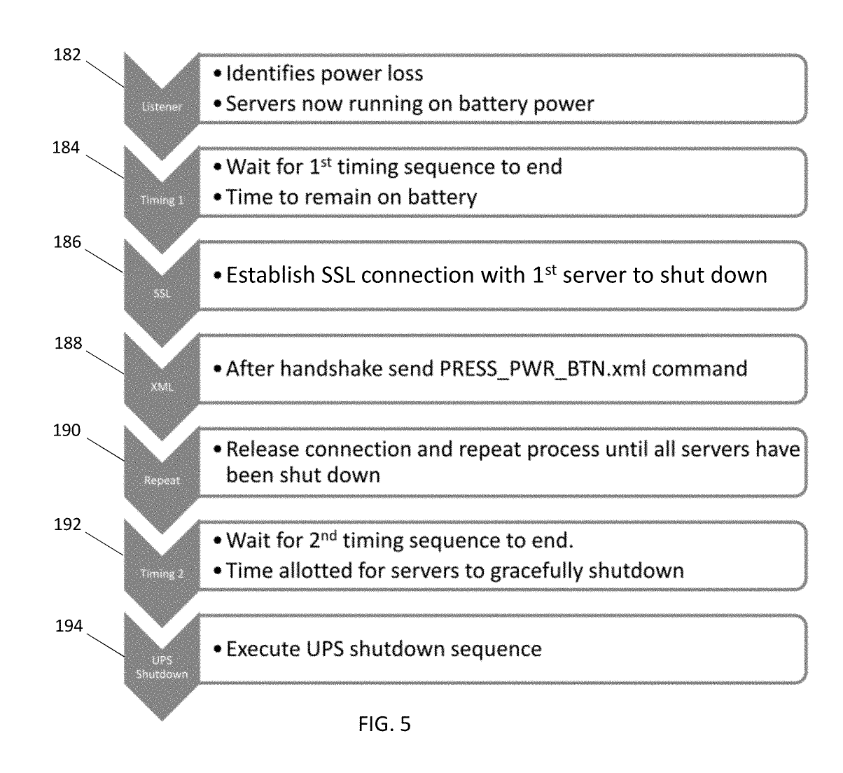

Method 160 includes initiating (at block 168) the action to modify the operating state of device 102 attached to UPS 100 when it is determined by UPS 100 that the action should be initiated. In some implementations, the action to modify the operating state of device 102 is an action to shutdown device 102. The action to showdown device 102 can, for example, be an action to perform a graceful shutdown of device 102. The term “graceful shutdown” as used herein can, for example, refer to a shutdown in which a “grace” period of time is provided to allow device 102 to properly shutdown. Alternatively, in some implementations, UPS 100 can initiate an immediate shutdown process. The type of shutdown process initiated by UPS 100 can, for example, be based on the functionality of device 102. For example, certain devices may not include an OS that allows for graceful shutdown. In some implementations, the graceful shutdown is based on an estimated time for shutting down device 102. The estimated time can, for example, be based on an estimated time to execute a command by UPS 100 to shut down the device and an estimated time for device 102 to shut down its operating system following receipt of the comment by UPS 100. UPS 100 can, in some implementations, be configured remotely to determine and initiate such graceful shutdown by computer 110. In some implementations, UPS 100 is configured locally using a direct input, such as a keyboard and monitor plugged into UPS 100. In some implementations, a memory resource of a controller of UPS 100 (e.g., a management card 118) is configured to automatically determine the power states of UPS 100 and device 102 and further to initiate modification of the operating state of device 102. The controller can, for example, use its own logic to initiate the command to shutdown device 102. As a result, device 102 can be deemed to be “agentless.” That is, instead of installing shutdown agent software on device 102 to initiate a shutdown once a shutdown command is received, existing logic already in place on such devices can be used to handle modification of the operating state. The existing logic of device 102 can, for example, receive a command and initiate a shutdown of device 102. As described in further detail below with respect to the timing diagram of FIG. 5, block 168 can include sending an XML command (or other suitable form of command) to device 102 to trigger a graceful shutdown of device 102.

In some implementations, initiating the action to modify the operating state of device 102 includes communicating between UPS 100 and device 102 via a network connection. The network connection can be a direct connection between UPS 100 and device 102 or can be a connection that passes through intermediary network equipment (e.g., switches, routers, gateways, etc.). In some implementations, initiating the action to modify the operating state of device 102 includes communicating between UPS 100 and device 102 without using a network connection, such as a USB cable.

Although the flowchart of FIG. 2 shows a specific order of performance, it is appreciated that this order may be rearranged into another suitable order, may be executed concurrently or with partial concurrence, or a combination thereof. Likewise, suitable additional and/or comparable steps may be added to method 160 or other methods described herein in order to achieve the same or comparable functionality. In some implementations, one or more steps are omitted. For example, in some implementations, block 162 of determining, with UPS 100, a power state of UPS 100 can be omitted from method 160 and/or replaced with another function. It is appreciated that blocks corresponding to additional or alternative functionality of other implementations described herein can be incorporated in method 160. For example, blocks corresponding to the functionality of various aspects of a UPS otherwise described herein can be incorporated in method 160 even if such functionality is not explicitly characterized herein as a block in method 160.

FIG. 3 is a diagram of a UPS, according to an example. For illustration, the description of UPS 100 of FIG. 3 makes reference to various aspects of the diagram of FIG. 1 and method 160 of FIG. 2. However it is appreciated that the UPS of FIG. 3 can include additional, alternative, or fewer aspects, functionality, etc., than the implementation described with respect to FIGS. 1 and 2 and the following description is not intended to be limited by the related disclosure thereof or vice-versa. As described in further detail below, UPS 100 includes a power supply output 170 and a management card 118. Management card 118 includes a processing resource 172 and a memory resource 174 that stores machine-readable instructions 176.

UPS 100 can, for example, be any suitable form or size. UPS 100 can, for example, be in the form of a standalone tower UPS. Such a tower UPS can, for example, stand upright on the ground or on a desk, shelf, or other surface and can, for example, be designed for used in certain network workstations or desktop computer applications. In some implementations, UPS 100 can be in the form of a rack-mountable UPS. Such a rack-mountable UPS can, for example, be designed to be mounted on a 19-inch rack enclosure and accommodate any suitable size rack space (e.g., from 1 U to 12 U or another suitable size). Such a rack-mountable UPS can, for example, be designed for use in certain server and networking applications. In some implementations, UPS 100 can, be designed to be placed inside a computer chassis. For example, a miniaturized UPS can be designed to fit into a 5.25-inch CD-ROM slot bay of a regular computer chassis.

Power supply output 170 of UPS 100 is provided to receive a power cable to supply power to device 102. Power supply output 170 can, for example, be in electrical or another form of communication with management card 118 to allow power supply output 170 to control an amount of power supplied to device 102. In some implementations, the power cable can include a power plug that can be removably plugged into power supply output 170. It is appreciated that power supply output 170 can be designed to receive other forms of removably or irremovable power cables. For example, in some implementations, UPS 100 is designed to receive a power cable to supply power to device 102 by soldering or otherwise “irremovably” attaching the power cable to power supply output 170. In some implementations, the power cable is a network cable, such as an Ethernet cable, and power is supplied to device 102 in accordance with a suitable Power over Ethernet (PoE) protocol.

Various aspects of various implementations of management card 118 are described above with respect to FIG. 1. However it is appreciated that the management card of FIG. 3 can include additional, alternative, or fewer aspects, functionality, etc., than the implementation described with respect to FIG. 1 and the following description is not intended to be limited by the related disclosure thereof or vice-versa. Management card 118 of FIG. 3 is in electrical communication with power supply output 170 and includes a processing resource 172 and a memory resource 174. Memory resource 174 stores machine readable instructions 176 to cause processing resource 172 to perform various functions. Although only a single set of instructions 176 is depicted in FIG. 3, it is appreciated that memory resource 174 can store additional or alternative machine readable instructions 176 to cause processing resource 172 to perform additional or alternative functions, such as those corresponding to one or more blocks of method 160 or other methods or implementations described herein.

Instructions 176 stored on memory resource 174 are, when executed by processing resource 172, to cause processing resource 172 to initiate a graceful shutdown sequence for device 102 based on a comparison performed by processing resource 172 of a rule stored on memory resource 174 to a power state of device 102. In some implementations, the comparison can be further based on the power state of UPS 100 and/or additional or alternative factors. Instructions 176 can incorporate one or more aspects of blocks of method 160 or another suitable aspect of other implementations described herein (and vice versa).

Processing resource 172 of UPS 100 can, for example, be in the form of a central processing unit (CPU), a semiconductor-based microprocessor, a digital signal processor (DSP) such as a digital image processing unit, other hardware devices or processing elements suitable to retrieve and execute instructions stored in memory resource 174, or suitable combinations thereof. Processing resource 172 can, for example, include single or multiple cores on a chip, multiple cores across multiple chips, multiple cores across multiple devices, or suitable combinations thereof. Processing resource 172 can be functional to fetch, decode, and execute instructions as described herein. As an alternative or in addition to retrieving and executing instructions, processing resource 172 can, for example, include at least one integrated circuit (IC), other control logic, other electronic circuits, or suitable combination thereof that include a number of electronic components for performing the functionality of instructions stored on memory resource 174. The term “logic” can, in some implementations, be an alternative or additional processing resource to perform a particular action and/or function, etc., described herein, which includes hardware, e.g., various forms of transistor logic, application specific integrated circuits (ASICs), etc., as opposed to machine executable instructions, e.g., software firmware, etc., stored in memory and executable by a processor. Processing resource 172 can, for example, be implemented across multiple processing units and instructions may be implemented by different processing units in different areas of UPS 100.

Memory resource 174 of UPS 100 can, for example, be in the form of a non-transitory machine-readable storage medium, such as a suitable electronic, magnetic, optical, or other physical storage apparatus to contain or store information such as machine-readable instructions 176. Such instructions can be operative to perform one or more functions described herein, such as those described herein with respect to method 160 or other methods described herein. Memory resource 174 can, for example, be housed within the same housing as processing resource 172 for UPS 100, such as within an enclosure for UPS 100. In some implementations, memory resource 174 and processing resource 172 are housed in different housings. As used herein, the term “machine-readable storage medium” can, for example, include Random Access Memory (RAM), flash memory, a storage drive (e.g., a hard disk), any type of storage disc (e.g., a Compact Disc Read Only Memory (CD-ROM), any other type of compact disc, a DVD, etc.), and the like, or a combination thereof. In some implementations, memory resource 174 can correspond to a memory including a main memory, such as a Random Access Memory (RAM), where software may reside during runtime, and a secondary memory. The secondary memory can, for example, include a nonvolatile memory where a copy of machine-readable instructions are stored. It is appreciated that both machine-readable instructions as well as related data can be stored on memory mediums and that multiple mediums can be treated as a single medium for purposes of description.

Processing resource 172 and memory resource 174 can, for example, be in communication via a communication link 178. Each communication link 178 can be local or remote to a machine (e.g., a UPS) associated with processing resource 172. Examples of a local communication link 178 can include an electronic bus internal to a machine (e.g., a computing device) where memory resource 174 is one of volatile, non-volatile, fixed, and/or removable storage medium in communication with processing resource 172 via the electronic bus.

In some implementations, one or more aspects of UPS 100 can be in the form of functional modules that can, for example, be operative to execute one or more processes of instructions 176 or other functions described herein relating to other implementations of the disclosure. As used herein, the term “module” refers to a combination of hardware (e.g., a processor such as an integrated circuit or other circuitry) and software (e.g., machine- or processor-executable instructions, commands, or code such as firmware, programming, or object code). A combination of hardware and software can include hardware only (i.e., a hardware element with no software elements), software hosted at hardware (e.g., software that is stored at a memory and executed or interpreted at a processor), or hardware and software hosted at hardware. It is further appreciated that the term “module” is additionally intended to refer to one or more modules or a combination of modules. Each module of UPS 100 can, for example, include one or more machine-readable storage mediums and one or more computer processors.

In view of the above, it is appreciated that the instructions of the UPS of FIG. 3 (and other implementations described herein) can correspond to separate and/or combined functional modules. For example, instructions 176 can correspond to a “graceful shutdown initiation module” to initiate a graceful shutdown sequence for device 102 based on a comparison performed by processing resource 172 of a rule stored on memory resource 174 to a power state of device 102. It is further appreciated that a given module can be used for multiple functions. As but one example, in some implementations, a single module can be used to both determine whether an action to modify an operating state of the device attached to the UPS should be initiated (e.g., corresponding to aspects of block 166 of method 160) as well as to initiate the action to modify the operating state of device 102 (e.g., corresponding to instructions 176).

UPS 100 can further include a suitable communication module to allow networked communication between UPS 100 and other elements of a network (e.g., LAN, WAN, or another suitable network). Such a communication module can, for example, include a network interface controller having an Ethernet port and/or a Fibre Channel port. In some implementations, such a communication module can include wired or wireless communication interface, and can, in some implementations, provide for virtual network ports. In some implementations, such a communication module includes hardware in the form of a hard drive, related firmware, and other software for allowing the hard drive to operatively communicate with other hardware of UPS 100 or other equipment. The communication module can, for example, include machine-readable instructions for use with communication the communication module, such as firmware for implementing physical or virtual network ports.

FIG. 4 is a diagram of machine-readable storage medium 180, according to an example. Medium 180 includes various instructions that can be executed by a computer processor or other processing resource. In some implementations, medium 180 can be housed within a UPS, such as certain implementations of UPS 100, or on another computing device in local or remote wired or wireless data communication with UPS 100.

For illustration, the description of machine-readable storage medium 180 provided herein makes reference to various aspects of UPS 100 (e.g., processing resource 172) and other implementations of the disclosure (e.g., method 160). Although one or more aspects of UPS 100 (as well as certain instructions, such as instructions 176) can be applied or otherwise incorporated with medium 180, it is appreciated that in some implementations, medium 180 may be stored or housed separately from such a system. For example, in some implementations, medium 180 can be in the form of Random Access Memory (RAM), flash memory, a storage drive (e.g., a hard disk), any type of storage disc (e.g., a Compact Disc Read Only Memory (CD-ROM), any other type of compact disc, a DVD, etc.), and the like, or a combination thereof. In some implementations, medium 180 is a physical medium housed within a physical chassis of an UPS, such as certain implementations of UPS 100.

Medium 180 includes machine-readable instructions 181 stored thereon to cause processing resource 172 to determine whether to modify the operating state of the device attached to the UPS, the determination being based on a comparison of the power state of the UPS and rules locally stored on the storage medium. Instructions 181 can, for example, incorporate one or more aspects of block 166 of method 160 or instructions 176 of UPS 100 or another suitable aspect of other implementations described herein (and vice versa).

Medium 180 includes machine-readable instructions 183 stored thereon to cause processing resource 172 to instruct the device attached to the UPS to modify its operating state. Instructions 183 can, for example, incorporate one or more aspects of block 168 of method 160 or instructions 176 of UPS 100 or another suitable aspect of other implementations described herein (and vice versa).

Medium 180 includes machine-readable instructions 176 stored thereon to cause processing resource 172 to determine whether to modify the operating state of a second device attached to UPS 100 (e.g., second device 102 for purposes of this example), the determination being based on a comparison of the power state of UPS 100, a power state of second device 102, and rules locally stored on medium 180. In such an implementations, medium 180 can further include machine-readable instructions 176 stored thereon to cause processing resource 172 to instruct second device 102 to modify its operating state.

FIG. 5 is a timing diagram, according to an example. This diagram illustrates various aspects of a specific example implementation. The use of specific examples (e.g., servers, XML commands, etc., are intended solely for illustration and are not intended to narrow the scope of the disclosure otherwise described herein. At block 182, a listener module on UPS 100 can identify power loss of devices 102 in the form of servers, which can for example indicate that the servers are running on battery power. At block 184, UPS 100 waits for a first timing sequence to end. The first timing sequence can, for example, provide a time for which the servers should remain on battery before any operating state modifications are performed. At block 186, UPS 100 can establish an SSL connection with a first server to shut down the server. At block 188, UPS 100 can send to the server (after a handshake is successfully performed with the server) a suitable XML command, such as a “PRESS_PWR_BTN.xml” command, which can, for example, include commands as follows:

<RIBCL VERSION=“2.0”>
<LOGIN USER_LOGIN=“admin” PASSWORD=“admin123”>
<SERVER_INFO MODE=“write”>
<PRESS_PWR_BTN/>
</SERVER_INFO>
</LOGIN>
</RIBCL>

It is appreciated that additional and/or alternative commands can be provided. At block 190, UPS 100 can release connections and repeat the above process until all servers connected to UPS 100 have been shut down. At block 192, UPS 100 waits for a second timing sequence to end. The second timing sequence can, for example, provide a time for which the servers are allowed to gracefully shut down. At block 194, UPS 100 can itself be shut down by executing a UPS shutdown sequence.

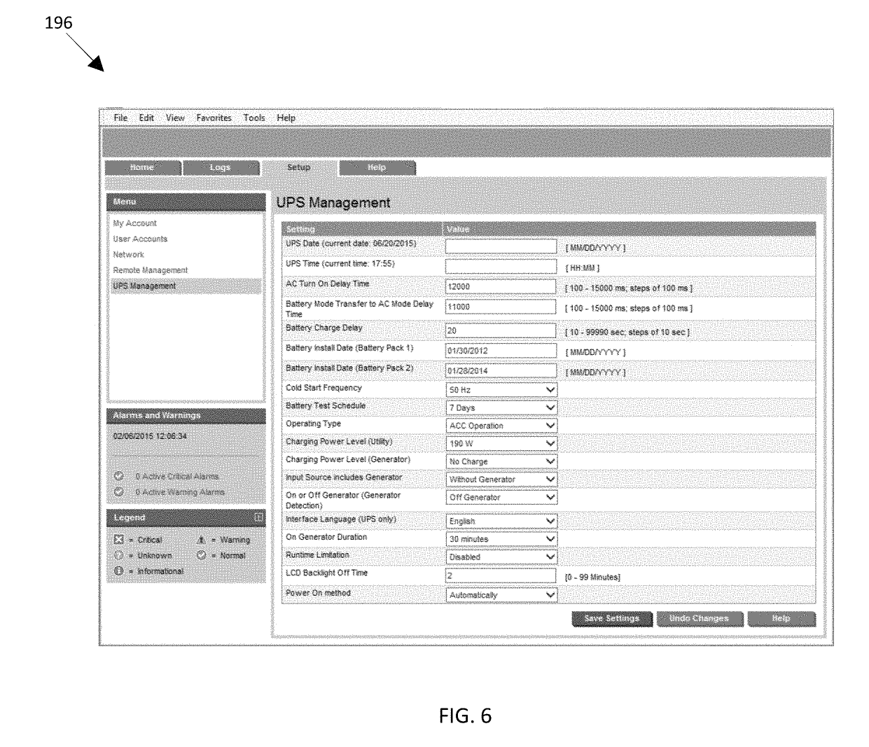

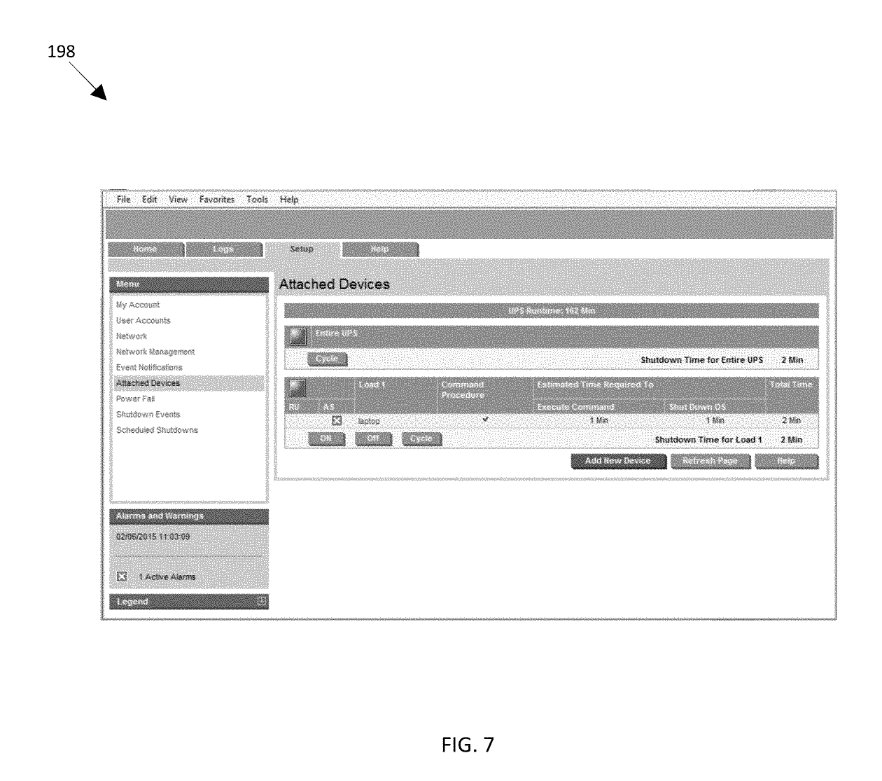

FIGS. 6-7 depict various GUIs for managing a UPS and attached devices. The use of specific examples (e.g., referring to the attached devices as “servers”, specific types of settings, etc., are intended solely for illustration and are not intended to narrow the scope of the disclosure otherwise described herein.

FIG. 6 is a GUI 196 for managing a UPS, according to an example. As shown in FIG. 6, various settings can be provided for managing UPS 100, such as settings relating to UPS Date, UPS Time, AC Turn On Delay Time, Battery Mode Transfer to AC Mode Delay Time, Battery Charge Delay, Battery Install Date (Battery Pack 1), Battery Install Date (Battery Pack 2), Cold Start Frequency, Battery Test Schedule, Operating Type, Charging Power Level (Utility), Charging Power Level (Generator), Input Source includes Generator, On or Off Generator (Generator Detection), Interface Language (UPS only), On Generator Duration, Runtime Limitation, LCD Backlight Off Time, Power On method.

FIG. 7 is a GUI 198 for managing devices attached to a UPS, according to an example. On GUI 198, a user can, for example, view and configure all servers or other devices that UPS 100 will shut down in the event of power loss. To add a new server a user can provide an Internet Protocol (IP) address and administrative credentials. The user can also set a timing of a shutdown sequence. There can, for example, be two timing variables. The first variable can configure the time frame the servers will remain on battery power before initiating the shutdown sequence. The second variable can designate how long UPS 100 will stay powered up to allow the servers to shut down. When this time expires UPS 100 will initiate its own shutdown sequence to protect the integrity of its battery.

FIG. 8 is a GUI 200 for managing shutdown parameters for devices attached to a UPS, according to an example. GUI 200 depicts settings for a master output, a load segment 1, and a load segment 2. As described above with respect to FIG. 2, determining whether an action to modify an operating state of a device attached to UPS 100 should be initiated can include matching the determined power state of UPS 100 and the determined power state of the device to a rule locally stored on UPS 100. Such a rule can, for example, include criteria based on various factors shown for example in FIG. 8, such as remaining backup time for UPS 100, percentage remaining battery capacity of UPS 100, a countdown timer indicating how long UPS 100 has been running on battery power (e.g., initiate shutdown sequence only after UPS 100 has been running on battery power for at least 1000 seconds). Such criteria can further include an estimated shutdown time for an OS running on device 102, as well as criteria relating to restarting device 102 after shutdown.

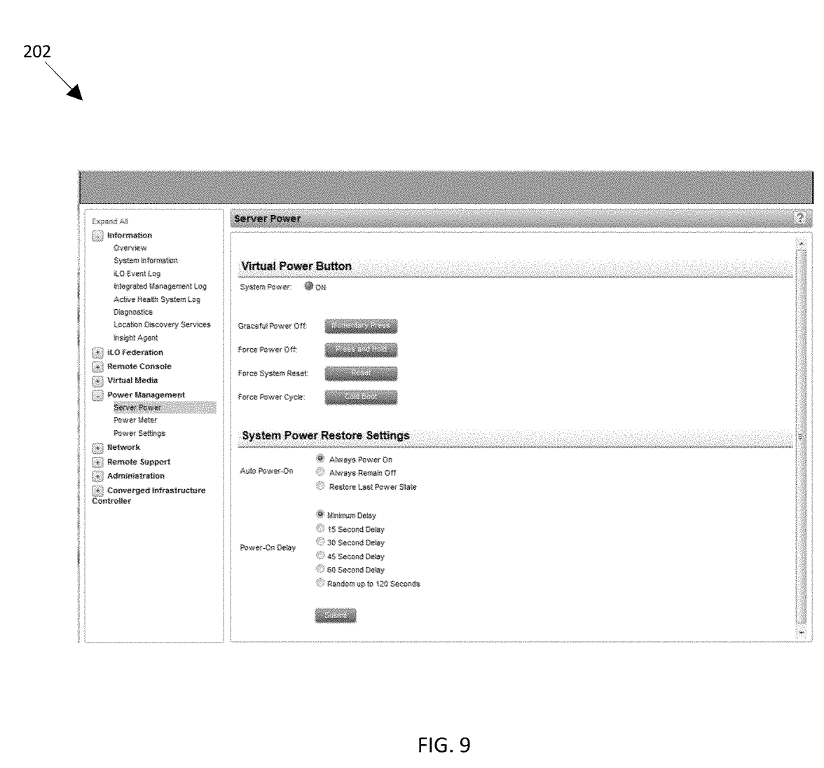

FIG. 9 is a GUI 202 for managing device power settings, according to an example. GUI 202 can include system power restore settings, such as Auto Power-On settings (e.g., “Always Power On”, “Always Remain Off”, “Restore Last Power State”) as well as Power-On Delays settings (e.g., “Minimum Delay”, “15 Second Delay”, “30 Second Delay”, “45 Second Delay”, “60 Second Delay”, “Random up to 120 Seconds”).

While certain implementations have been shown and described above, various changes in form and details may be made. For example, some features that have been described in relation to one implementation and/or process can be related to other implementations. In other words, processes, features, components, and/or properties described in relation to one implementation can be useful in other implementations. Furthermore, it should be appreciated that the systems and methods described herein can include various combinations and/or sub-combinations of the components and/or features of the different implementations described. Thus, features described with reference to one or more implementations can be combined with other implementations described herein.

As used herein, “logic” is an alternative or additional processing resource to perform a particular action and/or function, etc., described herein, which includes hardware, e.g., various forms of transistor logic, application specific integrated circuits (ASICs), etc., as opposed to machine executable instructions, e.g., software firmware, etc., stored in memory and executable by a processor. Further, as used herein, or “a number of” something can refer to one or more such things. For example, “a number of widgets” can refer to one or more widgets. Also, as used herein, “a plurality of” something can refer to more than one of such things.

What is claimed is:

1. A method comprising:
determining, with an Uninterruptible Power Supply (UPS), a power state of the UPS;
determining, with the UPS, a power state of a device attached to the UPS;
determining, with the UPS, whether an action to modify an operating state of the device attached to the UPS should be initiated based on the determined power state of the UPS and the power state of the device attached to the UPS; and
initiating, with the UPS, the action to modify the operating state of the device attached to the UPS when it is determined by the UPS that the action should be initiated.

2. The method of claim 1, wherein determining whether an action to modify the operating state of the device attached to the UPS should be initiated includes comparing the determined power state of the UPS and the determined power state of the device attached to the UPS using a local processor of a management card housed within the UPS.

3. The method of claim 1, wherein determining whether an action to modify the operating state of the device attached to the UPS should be initiated includes matching the determined power state of the UPS and the determined power state of the device to a rule locally stored on a management card housed within the UPS.

4. The method of claim 3, wherein the rule locally stored on the management card includes criteria based on remaining backup time for the UPS.

5. The method of claim 1, wherein initiating, with the UPS, the action to modify the operating state of the device attached to the UPS includes communicating within the device via a network connection.

6. The method of claim 1, wherein the power state of the UPS identifies whether adequate power is being supplied to the UPS by an external power source.

7. The method of claim 1, wherein the power state of the device attached to the UPS identifies whether the device is being supplied power by a battery housed within the device.

8. The method of claim 1, wherein the action to modify the operating state of the device attached to the UPS is an action to shutdown the device attached to the UPS.

9. The method of claim 8, wherein the action to shutdown the device attached to the UPS is a graceful shutdown of the device.

10. The method of claim 9, wherein the graceful shutdown is based on an estimated time for shutting down the device.

11. The method of claim 10, wherein the estimated time for shutting down the device is based on an estimated time to execute a command by the UPS to shutdown the device and an estimated time for the device to shutdown its operating system following receipt of the comment by the UPS.

12. A non-transitory machine readable storage medium to be housed within an Uninterruptible Power Supply (UPS) having stored thereon machine readable instructions to cause a computer processor of the UPS to:
determine whether to modify an operating state of a device attached to the UPS, the determination being based on a comparison of a power state of the UPS and rules locally stored on the storage medium; and
instruct the device attached to the UPS to modify its operating state.

13. The medium of claim 12, wherein the medium readable instructions are to cause a computer processor of the UPS to:
determine whether to modify an operating state of a second device attached to the UPS, the determination being based on a comparison of the power state of the UPS, a power state of the second device attached to the UPS, and rules locally stored on the storage medium; and
instruct the second device attached to the UPS to modify its operating state.

14. A Uninterruptible Power Source (UPS) comprising:
a power supply output to receive a power cable to supply power to a device attached to the UPS; and
a management card in electrical communication with the power supply outlet, the management card including a processing resource and a memory resource,
wherein the memory resource stores machine readable instructions to cause the processing resource to:
initiate a graceful shutdown sequence for the device attached to the UPS based on a comparison performed by the processing resource of the management card of a rule stored on the memory resource of the management card to a power state of the device attached to the UPS.

15. The UPS of claim 14, wherein the comparison is further based on the power state of the UPS.
